(19) United States
(12) Patent Application Publication
(10) Pub. No.: US 2026/0296799 A1
(43) Pub. Date: Oct. 1, 2026

(54) PRODUCT CONVEYING DEVICE AND SYSTEM

(71) Applicant: MULTIVAC SEPP HAGGENMÜLLER SE & CO. KG, Wolfertschwenden (DE)

(72) Inventor: Winfried HÖRBERG, Wolfertschwenden (DE)

(73) Assignee: MULTIVAC SEPP HAGGENMÜLLER SE & CO. KG, Wolfertschwenden (DE)

(21) Appl. No.: 19/571,766

(22) Filed: Mar. 19, 2026

(30) Foreign Application Priority Data
Mar. 28, 2025 (DE) 102025112217.2

(51) Int. Cl. B65G 47/30; B26D 7/06; B65B 25/06

(52) U.S. Cl. CPC B65G 47/30; B26D 7/0625; B65B 25/06; B26D 2210/02; B65G 2201/0202

(57) ABSTRACT

A product conveying device for products made from a foodstuff includes a product conveying unit designed to convey one or more products along a conveying direction, and a product loading unit designed to receive the one or more products from the product conveying unit and feed them to a packaging device at a transfer position. The product loading unit comprises a first product loading device and a second product loading device, which is arranged in the conveying direction, preferably directly, downstream of the first product loading device. The first product loading device has a first predetermined conveying angle with respect to a substantially horizontal direction and the second product loading device has a second predetermined conveying angle with respect to the substantially horizontal direction, wherein the second predetermined conveying angle is smaller than the first predetermined conveying angle. The disclosure furthermore relates to a system.

### CROSS-REFERENCE TO RELATED APPLICATIONS

This application claims foreign priority benefits under 35 U.S.C. § 119(a)-(d) to German patent application number DE 102025112217.2, filed Mar. 28, 2025, which is incorporated by reference in its entirety.

### TECHNICAL FIELD

The disclosure relates to a product conveying device for products made from a foodstuff, comprising a product conveying unit that is designed to convey one or more products along a conveying direction, and a product loading unit that is designed to receive the one or more products from the product conveying unit and feed them to a packaging device at a transfer position.

### SUMMARY

In order to assemble food products, i.e. products made from a foodstuff, such as, for example, slices of sausage, meat, cheese, or the like that have been cut using a slicing machine, in particular a slicer, into portions and to package them using a packaging device, it is known to first convey the products along a conveying direction using the product conveying unit and thereby align them, for example, in the conveying direction and/or substantially orthogonally to the conveying direction, so as to form a predetermined product or portion arrangement. Such a product or portion arrangement can comprise a plurality of product or portion rows arranged after one another in the conveying direction. Each product or portion row can comprise at least two products or portions, which can be arranged next to one another on the product conveying unit, substantially transverse to the conveying direction.

The product loading unit is ultimately intended to receive the one or more products from the product conveying unit and feed them to the packaging device at the transfer position.

The packaging device can be designed, for example, to be located below the product conveying device, to feed packaging elements to the transfer position in a direction substantially parallel to the conveying direction, so that the one or more products can be introduced, in particular dropped, preferably from above, into the packaging elements at the transfer position.

All of this also applies to the product conveying device according to the disclosure.

Particularly tall products, such as stacked or shingled portions of several slices of a foodstuff item, can tilt or tip over when being dropped into the packaging elements, because the loading unit often has a predetermined, relatively large conveying angle relative to a direction substantially parallel to the horizontal direction. This predetermined conveying angle is necessary in order to move the products from a product conveying level, along which the products are conveyed, towards a packaging element conveying level arranged below the product level, where the packaging elements are fed. The height difference between the product conveying level and the packaging element conveying level is generally the result of the fact that the packaging device has a certain height perpendicular to the conveying direction and the product conveying device is at least partially arranged above the packaging device.

Although product conveying devices are also known in which the products are conveyed to the transfer position only along a direction substantially parallel to the horizontal direction, such horizontal product conveying devices allow less design freedom in terms of the packaging device, since the packaging device usually has to be provided with a so-called "S-curve" or the like, which is structurally complex to achieve, with regard to a feed path for the packaging elements in order to ensure sufficient installation space for the packaging device.

It is therefore an object of the disclosure to remedy this defect.

This object is solved according to the disclosure by a product conveying device of the type mentioned in the introduction, in which the product loading unit comprises a first product loading device and a second product loading device, which is arranged in the conveying direction, preferably directly downstream of the first product loading device, wherein the first product loading device has a first predetermined conveying angle with respect to a substantially horizontal direction and the second product loading device has a second predetermined conveying angle with respect to the substantially horizontal direction, wherein the second predetermined conveying angle is smaller than the first predetermined conveying angle.

On account of the fact that, according to the disclosure, the second predetermined conveying angle is smaller, in particular in magnitude, than the first predetermined conveying angle, a loading angle, which preferably corresponds substantially to the second predetermined conveying angle, can be reduced when transferring the one or more products to the packaging device. This can reduce or completely eliminate inaccuracies, such as tilting, that occur when loading one or more products into one or more packaging elements, without having to restrict the installation space for a packaging device arranged, for example, below the product conveying device. The product conveying device according to the disclosure is particularly advantageous for products in the form of stacked or shingled portions, since these can tilt very easily during loading using conventionally designed loading units, which in the worst case means that the packaged products are spoilt and are unsaleable, or at least requires a subsequent correction of the loaded products.

The first predetermined conveying angle can be defined by the angle between a first product support level of the first product loading device and the substantially horizontal direction. Similarly, the second predetermined conveying angle of the second product loading unit can be defined by the angle between a second product support level of the second product loading unit and the substantially horizontal direction.

Each product can be composed of a foodstuff and can preferably be a portion, i.e., a food portion, or part of a portion. The term “product” can accordingly be understood in this application as a shorthand for the term “food product.” Each portion can, in turn, comprise one or more slices of a foodstuff. The slices can, for example, be separated from a product caliber by means of a slicing machine, preferably a slicer, arranged upstream of the product conveying unit with respect to the conveying direction.

Furthermore, the transfer position can be a position located at a front end of the product loading unit in the conveying direction or immediately downstream of the front end of the product loading unit in the conveying direction.

The packaging device can be, for example, a thermoforming packaging device or the like, in which the products are loaded into a packaging tray or container and can then be heat-sealed with a film or the like.

According to a preferred first embodiment, it is proposed that the second product loading device be fixedly arranged on the product conveying device. In other words, according to the first embodiment the second product loading device as a whole can be arranged immovably on the product conveying device, preferably along the conveying direction. In this way the second product loading device can be constructed in a simple manner, without having to provide a structurally complicated displacement mechanism or the like for the second product loading device. However, components of the second product loading device that enable the product conveying procedure itself to occur, such as a conveyor belt or the like, can of course be movable, for example circumferentially, without changing the position of the second product loading device as a whole.

In principle, the second predetermined conveying angle should be chosen as small as possible in order to minimise the risk of the product tilting during transfer to the packaging device, as described above. According to a preferred embodiment, the second predetermined conveying angle can be at most approximately 12°, preferably at most approximately 8°.

According to a preferred further development of the latter exemplary embodiment, the second predetermined conveying angle can be approximately 0° in order to reduce the tilting risk to a minimum. In other words, the second product loading device can extend substantially parallel to the substantially horizontal direction with respect to its conveying angle.

The first predetermined conveying angle, on the other hand, can in principle be chosen arbitrarily, though from a structural perspective it often depends on the height difference between the product conveying level and the packaging element conveying level described hereinbefore and/or other installation space requirements. Preferably, the first predetermined conveying angle can be more than approximately 10°, and preferably at most approximately 17°.

According to a second preferred exemplary embodiment, it is proposed that the second product loading device, as a whole, be arranged in a displaceable manner on the product conveying device, preferably in and/or counter to the substantially horizontal direction. In other words, the second product loading device according to the second embodiment can, for example, be designed as a so-called “retraction belt” or the like, which during a respective transfer of one or more products to the packaging device can be retracted substantially against the conveying direction in order to load the one or more products into one or more packaging elements by means of the so-called “tablecloth effect.” In this procedure, the retraction movement of the second product loading device effectively “removes the ground from under” the respective product, allowing said product to fall into a respective packaging element under the force of gravity, thereby minimising or, in the best case, completely preventing the product from tilting or tipping over. During the retraction movement of the second product loading device, the packaging element can preferably remain stationary, i.e., remain in place. The displacement of the second product loading device can be achieved, for example, by means of an electric drive unit and/or a corresponding linear guide, in which the second product loading device is movably guided along the substantially horizontal direction, or in a similar manner.

In order also to be able to form overlapping portions of products, in particular slices, that are arranged at least partially overlapping, it is further proposed that the first product loading device and the second product loading device be arranged, or can be arranged, at least partially overlapping seen in a top view. One or more products can thereby be moved back a predetermined amount, i.e., substantially against the conveying direction, after being transferred from the first product loading device to the second product loading device, until the product or products is/are partially arranged underneath the first product loading device. At least one further product can then be dropped from the first product loading device onto the product or products in such a way that it at least partially overlaps the first or subsequent products. If the second product loading device is movable as a whole, the overlapping arrangement can also be set only temporarily by a corresponding movement of the second product loading device relative to the first product loading device.

In order to enable the smoothest possible product transfer between the first and second product loading devices, according to a further exemplary embodiment it can be advantageous for the second predetermined conveying angle to be greater than 0°, in particular at least 5°. However, the second predetermined conveying angle should only be chosen sufficiently large so that the aforementioned problem of the products tilting during transfer to the packaging device is still reduced to a minimum.

Finally, the product conveying unit and/or the product loading unit, in particular the first product loading device and/or the second product loading device, can each be designed as one or more belt conveyors in a manner known per se. Each belt conveyor can, for example, be a circulating belt conveyor, in particular a single-track or multi-track conveyor, which preferably comprises at least one conveyor belt circulating endlessly around at least two oppositely arranged deflection rollers or guide rollers.

According to another aspect, the disclosure relates to a system comprising the afore-described product conveying device according to the disclosure and the packaging device, which includes a packaging provision unit designed and intended to provide one or more packaging elements, wherein each packaging element is designed to receive at least one product.

It should already be noted at this point that all statements, advantages, and effects described for the product conveying device according to the disclosure also apply to the system according to the disclosure, and vice versa.

According to one exemplary embodiment, the feed path of the packaging device, along which the one or more packaging elements is/are fed to the transfer position, can extend substantially straight, preferably substantially parallel to the substantially horizontal direction. Consequently, the packaging device can be designed in a structurally simple and cost-effective manner, and/or in particular, the feed path can be free of any deflection of the packaging elements, such as an S-curve or the like. Preferably, the entire feed path extends substantially straight, preferably substantially parallel to the substantially horizontal direction.

According to a further preferred exemplary embodiment, the system can also include a slicing machine, in particular a slicer, which is arranged upstream of the product conveying device with respect to the conveying direction and is preferably designed to slice at least one product caliber into slices and feed them to the product conveying device as products in the form of portions, wherein each portion comprises one or more of the slices. The slicing machine can be designed to slice foodstuffs, particularly in the form of so-called product calibers, into slices from which preferably shingled or stacked portions can be formed. The product calibers can be formed, for example, from sausage, cheese, grown meat, pressed meat, and the like. A feeding unit of the slicing machine, by means of which the product calibers can be fed to a cutting unit of the slicing machine, can, for example, be designed as an endlessly circulating belt conveyor or the like. Preferably, the cutting unit is arranged downstream of the feeding unit with respect to the conveying direction. By means of a knife, which can be mounted on the cutting unit and driven about a rotation axis, the slices can be cut from one end of a respective product caliber facing the cutting unit.

In addition, the packaging provision unit can be designed to feed the packaging elements to the transfer position in a direction substantially parallel to the conveying direction. This is particularly advantageous if the product conveying device and the packaging device are arranged at least partially above one another and/or parallel to one another. In this connection, the product conveying device can be located on a first height level, and the packaging device can be located on a second level arranged below the first level. Consequently, the one or more products can be introduced, in particular dropped, into a respective packaging element at the transfer position from above by means of the product conveying device.

### BRIEF DESCRIPTION OF THE DRAWINGS

The disclosure will be explained in more detail below with reference to the accompanying drawings and exemplary embodiments, in which:

FIG. 1 is a schematic side view of a system according to the disclosure, comprising a product conveying device according to the disclosure, a packaging device, and a slicing machine; and

FIG. 2 is a schematic side view of an exemplary embodiment of a slicing machine for the system according to the disclosure.

### DETAILED DESCRIPTION

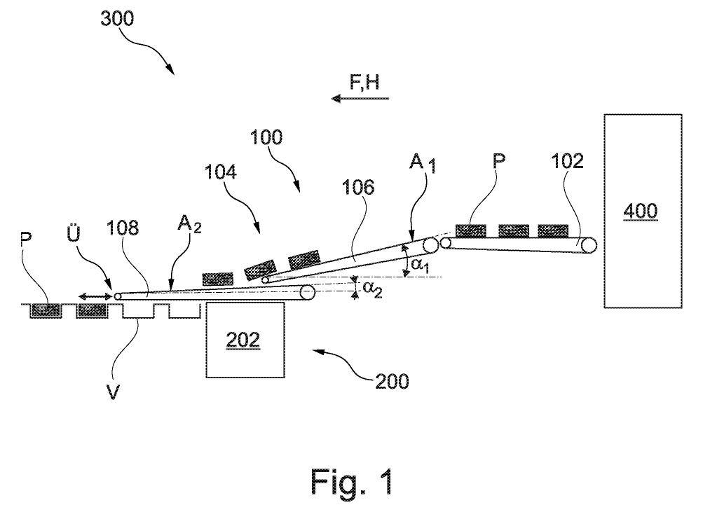

In FIG. 1, a system according to the disclosure is generally characterised by the reference numeral 300.

The system 300 comprises a product conveying device 100 according to the disclosure, a packaging device 200, and a slicing machine 400.

According to the disclosure, the product conveying device 100 comprises a product conveying unit 102, which is designed to convey one or more products P along a conveying direction F. The products P can be, for example, slices S or portions of one or more slices S, which have been previously sliced by means of the slicing machine 400.

In the exemplary embodiment shown in FIG. 1, a product loading unit 104 is arranged downstream of the product conveying unit 102 in the conveying direction F, said loading unit being designed to receive one or more products P from the product conveying unit 102 and feed them to the packaging device 200 at a transfer position Ü.

A special feature of the product conveying device 100 according to the disclosure is that the product loading unit 104 comprises a first product loading device 106 and a second product loading device 108, which is arranged immediately downstream of the first product loading device 106 in the conveying direction F. The first product loading device 106 has a first predetermined conveying angle α1 with respect to a substantially horizontal direction H, and the second product loading device 108 has a second predetermined conveying angle α2 with respect to the substantially horizontal direction H. According to the disclosure, the second predetermined conveying angle α2 is smaller than the first predetermined conveying angle α1. The second predetermined conveying angle α2 can have a value greater than 0°, but alternatively it can also be approximately 0°. In the illustrated exemplary embodiment the substantially horizontal direction H corresponds to the conveying direction F or a direction parallel thereto.

On account of the fact that the second predetermined conveying angle α2 is chosen to be as small as possible according to the disclosure, products P fed to the transfer position Ü can be loaded into packaging elements V without tilting, which are fed to the packaging device 200 by means of a packaging provision unit 202, such as a conveying device (e.g., one or more belt conveyors). However, if the second predetermined conveying angle α2 were, for example, as large as the first predetermined conveying angle α1, this could lead to a product P entering the opening of a packaging element V obliquely and becoming stuck in the packaging element V in an only partially inserted, slanted orientation. Since the packaging elements V should however be chosen as small as possible simply for logistical reasons, and the opening of a packaging element V should accordingly not be much larger than the corresponding dimensions of a given product P, it is necessary to load the products into the packaging elements V in a state that is as horizontally aligned as possible.

The first predetermined conveying angle α1 can be defined by the angle between a first product support level A1 of the first product loading device 106 and the substantially horizontal direction H. The second predetermined conveying angle α2 can correspondingly be defined by the angle between a second product support level A2 of the second product loading device 108 and the substantially horizontal direction H.

According to a first exemplary embodiment, it is possible for the second product loading device 108 to be fixedly arranged on the product conveying device 100, i.e., it is not displaceable as a whole along the substantially horizontal direction H. According to a second exemplary embodiment, the second product loading device 108 can however be displaceable as a whole, preferably in and/or against the substantially horizontal direction H, for example by means of an electric drive unit or the like, as indicated in FIG. 1 by a corresponding double arrow at a front end of the second product loading device 108 in the conveying direction F. According to the second exemplary embodiment, the second product loading device 108 can, for example, be designed as a so-called "retraction belt", in which a retraction movement of the second product loading device 108 against the conveying direction F effectively "removes the ground from under the products P," so that a respective product P can fall into its respective packaging element V under the effect of gravity without tilting.

In order also to be able to form overlapping portions of products P, in particular slices S, that are arranged at least partially overlapping, the first product loading device 106 and the second product loading device 108, as shown in FIG. 1, can be arranged, or are arrangeable, at least partially overlapping in the conveying direction F. If the second product loading device 108 is designed to be moveable, as described hereinbefore according to the second embodiment, the overlapping arrangement can accordingly be only temporary, if desired.

It should also be noted that the product conveying unit 102 and/or the product loading unit 104, in particular the first product loading device 106 and/or the second product loading device 108, can in each case be designed as one or more, preferably single-track or multi-track, belt conveyors.

The packaging device 200, which is also shown only schematically in FIG. 1, can, for example, be designed as a thermoforming packaging device or the like, in which the products P can be loaded into the packaging elements V in the form of packaging containers or trays and then sealed with a film (not shown). In that regard, as one skilled in the art would understand, the packaging device 200 may include, for example, one or more molds for thermoforming the packaging elements V and/or one or more sealing devices, such as one or more sealing bars or plates, for sealing a film onto the packaging elements V.

A feed path of the packaging device 200, along which the packaging elements V are fed to the transfer position Ü and beyond, can extend substantially straight, preferably substantially parallel to the substantially horizontal direction H. The packaging device 200, or parts thereof, can in particular extend further in and/or against the substantially horizontal direction H than indicated in FIG. 1. For example, parts of the packaging device 200 can also be arranged below the first product loading device 106 and/or the product conveying unit 102.

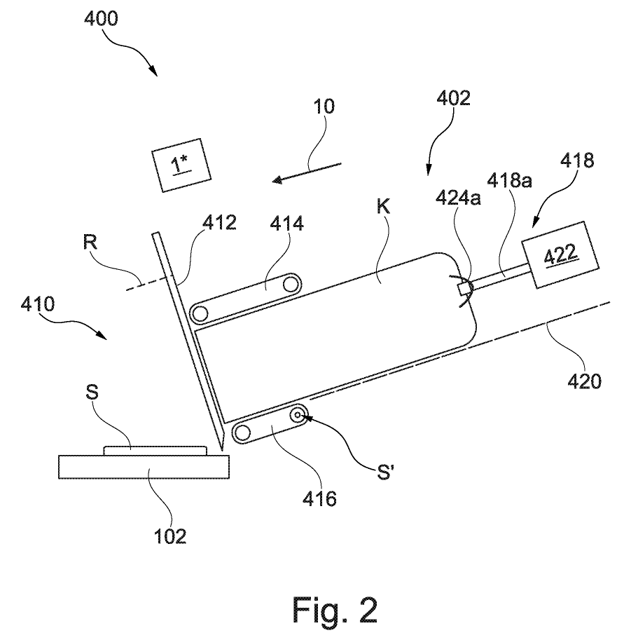

In FIG. 2, an exemplary embodiment of the slicing machine 400, indicated in FIG. 1 only by a black box, is shown schematically in a side view.

The slicing machine 400 can be designed as a single-track or multi-track slicing machine, wherein in the side view according to FIG. 2 only an outermost track of the slicing machine 400 is visible.

The slicing machine 400 comprises a feeding unit 402, which is designed to feed at least one product caliber K along a feeding direction 10 to a cutting unit 410. The cutting unit 410 can include a knife 412 according to the disclosure, which can be rotatably driven about a rotation axis R, for example by means of an electric drive unit (not shown). The knife 412 can, for example, be designed as a sickle knife, which preferably has a radius that varies about the rotation axis R, and in particular increases in the direction of rotation about the rotation axis R. Consequently, during a partial rotation about the rotation axis R, the knife 412 can first of all create a cutting gap and enable the product caliber K to advance in the feeding direction 10, and during further rotation about the rotation axis R it can each time cut off a slice S from the product caliber K. The slices S can then fall as products P onto the product conveying unit 102 or a portioning unit (not shown) arranged between the product conveying unit 102 and the slicing machine 400. For example, corresponding portions can be formed by stacking or shingling several slices S.

At one front end, the at least one product caliber K can be guided by an upper traction belt 414 and/or a lower traction belt 416. The upper traction belt 414 and/or the lower traction belt 416 can in this connection be driven separately. However, it is generally sufficient if at least either the upper traction belt 414 or the lower traction belt 416 can be continuously driven in and preferably against the feed direction 10. In the illustrated embodiment the lower traction belt 416 can, for example, pivot about a pivot axis S', so that it can be pivoted upwards when the slicing machine 400 is loaded, in order to serve as a stop for the at least one product caliber K when it is gripped by a gripper unit 418.

Furthermore, the slicing machine 400 can include the gripper unit 418 with at least one gripper 418a, which can be designed to grip the product caliber K at one end facing away from the cutting unit 410. In the present exemplary embodiment, the gripper unit 418 includes at least the gripper 418a, wherein in the case of a multi-track slicing machine, an additional gripper configured corresponding to the gripper 418a can be provided per track. The gripper 418a or the grippers can be arranged on a common gripper carriage 422. Furthermore, a detection sensor 424a can be assigned to the gripper 418a, and optionally to each additional gripper, wherein the sensor can, for example, be designed to detect when the gripper 418a touches the product caliber K.

Before and/or during slicing, the at least one product caliber K can rest on a feeder 420, which can be designed as a belt conveyor and is also shown only schematically in FIG. 2.

Furthermore, a control unit 1* of the slicing machine 400 is schematically indicated in FIG. 2., by means of which the cutting unit 410, the feeder unit 402 of the slicing machine 400, and preferably all other moving parts of the slicing machine 400 can be controlled. The upper traction belt 414, the lower traction belt 416, the feeder 420, and the gripper unit 418 can be assigned to the feeding unit 402. Furthermore, it is in principle conceivable to connect the control unit 1* also operationally to the product conveying device 100 and/or the packaging device 200, or to provide a separate control unit for each of these devices.

What is claimed is:

1. A product conveying device for products made from a foodstuff, comprising:
a product conveying unit which is designed to convey one or more products along a conveying direction; and
a product loading unit which is designed to receive the one or more products from the product conveying unit and feed them to a packaging device at a transfer position;
wherein the product loading unit comprises a first product loading device and a second product loading device, which is arranged in the conveying direction downstream of the first product loading device, wherein the first product loading device has a first predetermined conveying angle with respect to a substantially horizontal direction and the second product loading device has a second predetermined conveying angle with respect to the substantially horizontal direction, and wherein the second predetermined conveying angle is smaller than the first predetermined conveying angle.

2. The product conveying device according to claim 1, wherein the second product loading device is fixedly arranged on the product conveying device.

3. The product conveying device according to claim 1, wherein the second predetermined conveying angle is at most approximately 12°.

4. The product conveying device according to claim 3, wherein the second predetermined conveying angle is at most approximately 8°.

5. The product conveying device according to claim 3, wherein the second predetermined conveying angle is approximately 0°.

6. The product conveying device according to claim 1, wherein the first predetermined conveying angle is more than approximately 10°.

7. The product conveying device according to claim 6, wherein the first predetermined conveying angle is at most approximately 17°.

8. The product conveying device according to claim 1, wherein the second product loading device, as a whole, is displaceably arranged on the product conveying device.

9. The product conveying device according to claim 8, wherein the second product loading device is displaceable in and/or against the substantially horizontal direction.

10. The product conveying device according to claim 1, wherein the first product loading device and the second product loading device are arranged, or can be arranged, overlapping at least partially seen in a top view.

11. The product conveying device according to claim 1, wherein the second predetermined conveying angle is greater than 0°.

12. The product conveying device according to claim 11, wherein the second predetermined conveying angle is at least 5°.

13. The product conveying device according to claim 1, wherein the product conveying unit and/or the product loading unit comprise/comprises one or more belt conveyors.

14. The product conveying device according to claim 1, wherein the first product loading device and/or the second product loading device of the product loading unit comprise/comprises one or more belt conveyors.

15. A system, comprising:
the product conveying device according to claim 1, and
a packaging device, which includes a packaging provision unit that is designed to provide one or more packaging elements, wherein each packaging element is designed to receive at least one product.

16. The system according to claim 15, wherein a feed path of the packaging device, along which the one or more packaging elements are fed to the transfer position, extends substantially straight.

17. The system according to claim 16, wherein the feed path extends substantially parallel to the substantially horizontal direction.

18. The system according to claim 15, further comprising a slicing machine, which is arranged upstream of the product conveying device with respect to the conveying direction and is designed to slice at least one product caliber into slices and to feed the product conveying device the slices as products formed as portions, wherein each portion comprises one or more of the slices.

19. The system according to claim 15, wherein the packaging provision unit is designed to feed the packaging elements to the transfer position in a direction substantially parallel to the conveying direction.
